(19) United States
(12) Patent Application Publication
(10) Pub. No.: US 2006/0061883 A1
(43) Pub. Date: Mar. 23, 2006

(54) REVENTING POINT OF IMPACT SHIFT

(76) Inventor: Chen-Yeh Lin, Taichung (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/905,188

(22) Filed: Dec. 21, 2004

(30) Foreign Application Priority Data
Sep. 22, 2004 (TW) 93128689

(51) Int. Cl. G02B 7/02

(52) U.S. Cl. 359/811

(57) ABSTRACT

A mechanism for preventing point of impact shift inside a variable focus system. The mechanism for preventing point of impact shift comprises a first lens chamber, a second lens chamber, a first arresting spring and a second arresting spring. The first and the second lens chamber are disposed within an internal sleeve but separated from each other by a distance. The first and the second lens chamber can slide within the internal sleeve and each lens chamber has an individual groove. The first arresting spring is disposed inside the groove in the first lens chamber such that the first arresting spring is elastically deformed between the internal sleeve and the first lens chamber. The second arresting spring is disposed inside the groove in the second lens chamber such that the second arresting spring is elastically deformed between the internal sleeve and the second lens chamber.

### CROSS-REFERENCE TO RELATED APPLICATION

This application claims the priority benefit of Taiwan application serial No. 93128689, filed Sep. 22, 2004.

### BACKGROUND OF THE INVENTION

1. Field of the Invention

The present invention relates to a variable focus system. More particularly, the present invention relates to a mechanism for preventing point of impact shift inside a variable focus system.

2. Description of the Related Art

With the rapid development of high-tech equipment in recent years, many types of optical devices including cameras, digital cameras, projectors, telescopes and aiming device are designed with a variable focus system to meet the needs of users. All these optical devices with variable focusing capability frequently utilize a variable focus mechanism to change the relative position between the different lenses and provide a zooming effect.

FIG. 1 is a split-up view of various components constituting a conventional variable focus system. FIG. 2 is a schematic cross-sectional view of a conventional variable focus system. The variable focus system 100 in FIGS. 1 and 2 comprises an internal sleeve 110, a first lens chamber 120 and a second lens chamber 130. Both the first lens chamber 120 and the second lens chamber 130 are disposed within the internal sleeve 110. Furthermore, the first lens chamber 120 and the second lens chamber 130 can slide within the internal sleeve 130 in order to achieve a variable focusing effect.

The first and the second lens chamber 120, 130 slides inside the internal sleeve 110 via fixed pins 150. The internal sleeve 110 has a first sliding groove 112 and a second sliding groove 114 that correspond to the first and the second lens chamber 120, 130. The fixed pins 150 pass through the first and the second sliding grooves 112, 114 and lock onto the first and the second lens chamber 120, 130 respectively. Furthermore, the fixed pins 150 can move inside the first and the second sliding groove 112, 114 a first path distance and a second path distance respectively so that the location of the first and the second lens chamber 120, 130 can change to vary the focus.

In the aforementioned variable focus mechanism 100, the fixed pins 150 will slide along the first and the second sliding groove 112, 114 to move the first and the second lens chamber 120, 130 to the left or right. However, there is gap between the first/the second lens chamber 120, 130 and the internal sleeve 110, respectively. The gap exists because of the need to have a minimum tolerance for sliding the first lens chamber 120 and the second lens chamber 130 into the internal sleeve 110 during the assembling process. However, since the presence of the gap, the first lens chamber 120 and the second lens chamber 130 may wobble a little when the first and the second lens chamber 120, 130 slide within the internal sleeve 110. Ultimately, this may lead to a point of impact shift in the image. To reduce the degree of rocking inside the internal sleeve due to a loose dimensional tolerance, the machining precision of the lens chamber and the internal sleeve is often increased to bring down the tolerance gap. However, increasing the precision means a higher cost of fabrication or a drop in the yield of the assembled device.

### SUMMARY OF THE INVENTION

Accordingly, at least one objective of the present invention is to provide a mechanism for preventing point of impact shift when the focus is changed in a variable focus system.

To achieve these and other advantages and in accordance with the purpose of the invention, as embodied and broadly described herein, the invention provides a mechanism for preventing point of impact shift in a variable focus system. The mechanism comprises a first lens chamber, a second lens chamber, a first arresting spring and a second arresting spring. The first lens chamber and the second lens chamber are disposed inside the internal sleeve and separated from each other by a distance. Furthermore, the first and the second lens chambers are free to slide within the internal sleeve. The perimeter of the first and the second lens chamber has a groove. The first arresting spring is disposed inside the groove of the first lens chamber such that the first arresting spring is elastically deformed within the gap between the internal sleeve and the first lens chamber. Similarly, the second arresting spring is disposed inside the groove of the second lens chamber such that the second arresting spring is elastically deformed within the gap between the internal sleeve and the second lens chamber.

In the aforementioned mechanism for preventing point of impact shift, the first lens chamber comprises a plurality of lenses and a fastening mount. The lenses are disposed on the fastening mount and the groove is disposed on the perimeter of the fastening mount. In addition, the second lens chamber comprises a plurality of lenses and a fastening mount such that the lenses are disposed on the fastening mount and the groove is disposed on the perimeter of the fastening mount.

In the aforementioned mechanism for preventing point of impact shift, the first lens chamber can slide within the internal sleeve through a restraining fixed pin. The internal sleeve has a first sliding groove. The fixed pin passes through the first sliding groove and locks onto the first lens chamber such that the fixed pin can move along the first sliding groove for a first path distance.

In the aforementioned mechanism for preventing point of impact shift, the second lens chamber can slide within the internal sleeve through a restraining fixed pin. The internal sleeve has a second sliding groove. The fixed pin passes through the second sliding groove and locks onto the second lens chamber such that the fixed pin can move along the second sliding groove for a second path distance.

In the aforementioned mechanism for preventing point of impact shift, the first and the second arresting spring are fabricated using metal, for example. The first and the second arresting spring are arc-shaped spring plates, for example.

The present invention provides a mechanism for preventing point of impact shift. The mechanism relies on an elastically deformed first and a second arresting spring inside a groove to press against the internal sleeve so that the area in first and the second lens chamber located diametrically opposite to the groove also presses against the internal sleeve. Therefore, the first and the second lens chamber can slide within the internal sleeve with very little wobble. In other words, the mechanism in the present invention for preventing the point of impact shift in a variable focus system can stabilize the sliding action of the first and the second lens chamber when the focus is changed.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a split-up view of various components constituting a conventional variable focus system.

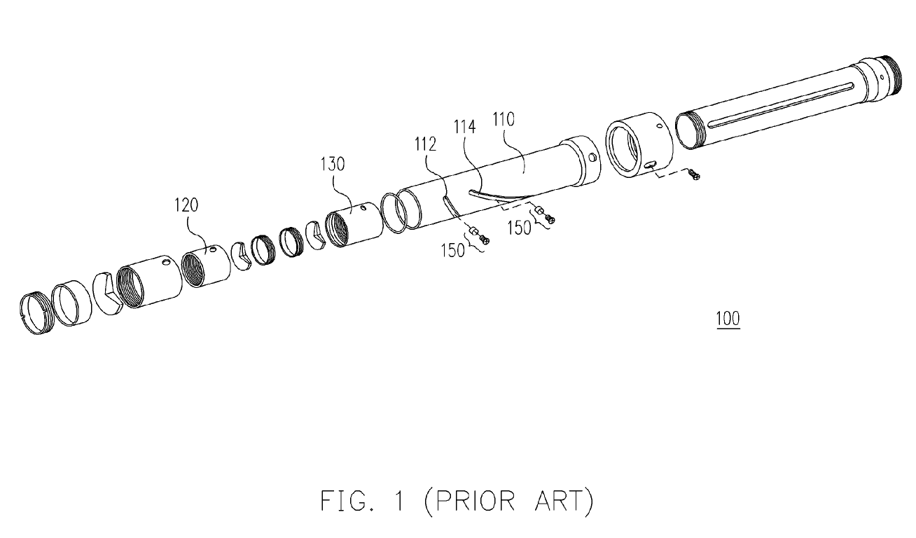

FIG. 2 is a schematic cross-sectional view of a conventional variable focus system.

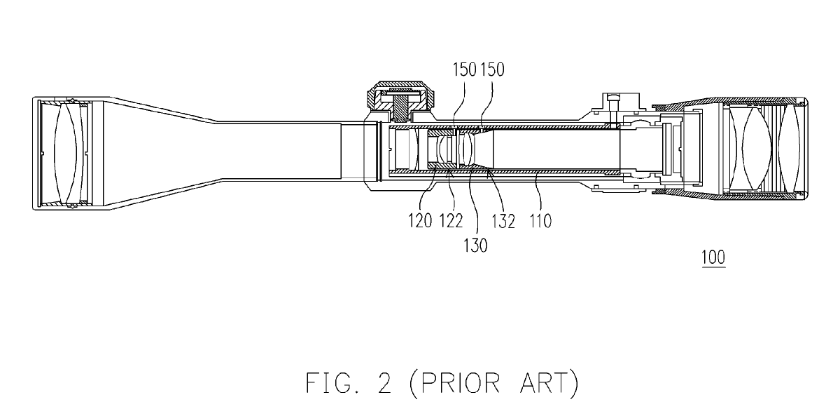

FIG. 3 is a schematic cross-sectional view showing a mechanism for prevention point of impact shift disposed inside an internal sleeve according to the present invention.

FIG. 4 is a schematic cross-sectional view along line I-I′ of FIG. 3.

FIG. 5 is a schematic cross-sectional view showing the mechanical movement of the mechanism for preventing point of impact shift within the internal sleeve according to the present invention.

FIG. 6 is a perspective view showing the external structure of an internal sleeve according to one preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

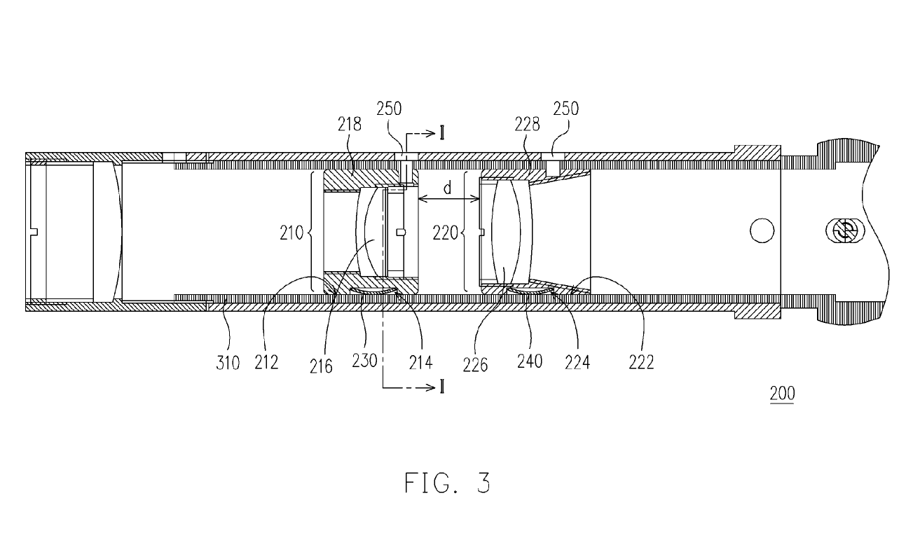

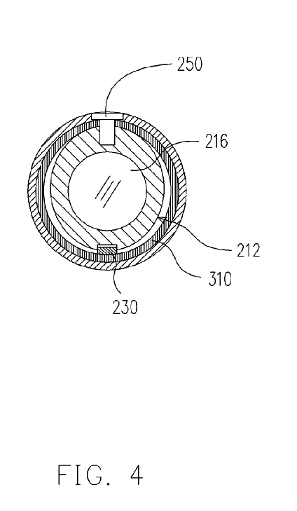

FIG. 3 is a schematic cross-sectional view showing a mechanism for prevention point of impact shift disposed inside an internal sleeve according to the present invention. FIG. 4 is a schematic cross-sectional view along line I-I′ of FIG. 3. As shown in FIGS. 3 and 4, the mechanism 200 for preventing point of impact shift in the present embodiment is commonly adapted to a variable focus system (not shown) such as an aiming device for shooting. The mechanism 200 for preventing point of impact shift comprises a first lens chamber 210, a second lens chamber 220, a first arresting spring 230 and a second arresting spring 240. The first lens chamber 210 and the second lens chamber 220 are disposed inside an internal sleeve 310 and separated from each other by a distance d. Furthermore, the first and the second lens chambers 210, 220 are free to slide within the internal sleeve 310. The perimeters 212, 222 of the first and the second lens chamber 210, 220 have a groove 214, 224 respectively. The first and the second arresting spring 230, 240 are an arc-shaped spring plate fabricated using metal, for example. The first arresting spring 230 is disposed inside the groove 214 of the first lens chamber 210 such that the first arresting spring 230 is elastically deformed within the gap between the internal sleeve 310 and the first lens chamber 210. Similarly, the second arresting spring 240 is disposed inside the groove 224 of the second lens chamber 220 such that the second arresting spring 240 is elastically deformed within the gap between the internal sleeve 31—and the second lens chamber 220.

The first lens chamber 210 further comprises a set of lenses 216 and a fastening mount 218. The lenses 216 are disposed on the fastening mount 218 and the groove 214 is disposed on the perimeter 212 of the fastening mount 218. Similarly, the second lens chamber 220 further comprises a set of lenses 226 and a fastening mount 228. The lenses 226 are disposed on the fastening mount 228 and the groove 224 is disposed on the perimeter 222 of the fastening mount 228.

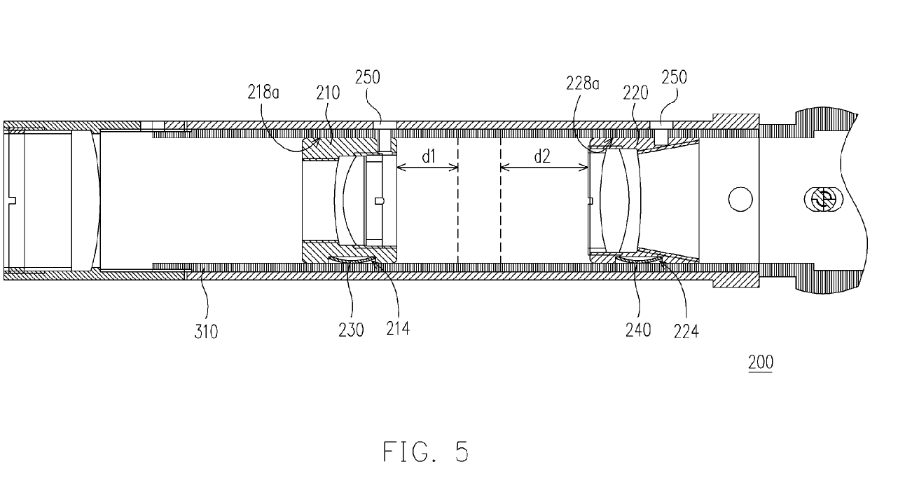

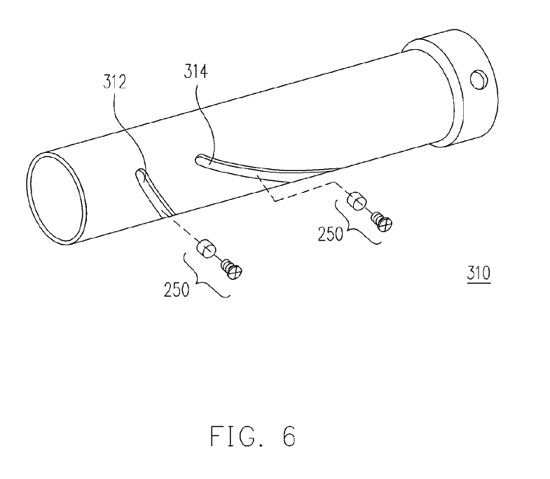

FIG. 5 is a schematic cross-sectional view showing the mechanical movement of the mechanism for preventing point of impact shift within the internal sleeve according to the present invention. FIG. 6 is a perspective view showing the external structure of an internal sleeve according to one preferred embodiment of the present invention. As shown in FIGS. 3, 5 and 6, the first lens chamber 210 can slide inside the internal sleeve 310 to change the focus in a variable focus system (not shown). For example, the first lens chamber 210 slides inside the internal sleeve 310 through the restraining action of a fixed pin 250. The internal sleeve 310 has a first sliding groove 312 and the fixed pin 250 passes through the first sliding groove 312 and tightens to the first lens chamber 210. Hence, the fixed pin 250 can move along the first sliding groove 312 for a first path distance and drive the first lens chamber 210 to the left or right by a distance. In the present embodiment, the first lens chamber 210 is driven to the left by a distance d1. Since the first arresting spring 230 is elastically compressed against the interior wall of the internal sleeve 310, the area on the perimeter 212 of the fastening mount 218 at the diametrically opposite position of the groove 214 is also pressed against the interior wall of the internal sleeve 310. Hence, the first lens chamber 210 can move forward inside the internal sleeve 310 with and greater stability and less wobbling so that a shooting target can be more accurately aimed.

In the meantime, the second lens chamber 220 will also slide inside the internal sleeve 310 when the focus of the variable focus system is changed. The second lens chamber 220 is also designed to slide inside the internal sleeve 310 through the restraining action of a fixed pin 250. The internal sleeve 310 also has a second sliding groove 314 such that the fixed pin 250 can pass through the second sliding groove 314 and tighten to the second lens chamber 220. The fixed pin 250 can move along the second sliding groove 314 for a second path distance and drive the second lens chamber 220 to the left or right by a distance. In the present embodiment, the second lens chamber 220 is driven to the right by a distance d2. Since the second arresting spring 240 is elastically compressed against the interior wall of the internal sleeve 310, the area on the perimeter 222 of the fastening mount 228 at the diametrically opposite position of the groove 224 is also pressed against the interior wall of the internal sleeve 310. Hence, the second lens chamber 220 can move forward inside the internal sleeve 310 with and greater stability and less wobbling so that a shooting target can be more accurately aimed.

It should be noted that the variable focus system in the present embodiment varies the focus by sliding the first and the second lens chamber 210, 220 within the internal sleeve 310. However, there is no need to move the first and the second lens chamber 210, 220 inside the internal sleeve 310 at the same time. In other words, zooming effect can be achieved by moving either the first lens chamber 210 or the second lens chamber 220.

Furthermore, a first arresting plate 230 and a second arresting plate 240 are used to press the first and the second lens chamber 210, 220 against the internal sleeve 310. Hence, there is no need to provide extra fine tolerance between the first and the second lens chamber 210, 220 on one hand and the internal sleeve 310 on the other to improve motion stability. In other words, the tolerance between the first and the second lens chamber 210, 220 and the internal sleeve 310 can be relaxed to increase the yield of the first and the second lens chamber 210, 220. In addition, the assembling rate can be increased and the production lowered when a higher tolerance between the lens chamber 210, 220 and the internal sleeve 310 is adopted.

Because the first and the second lens chamber 210, 220 can move inside the internal sleeve 310 with very little wobbling, the first and second lens chamber 210, 220 are rarely jammed when the focus is changed. In other words, the focus can be easily changed through an adjustment of the first and second lens chamber 210, 220.

In summary, the mechanism for preventing point of impact shift according to the present invention has a first and a second arresting spring installed within the groove of the first and the second chamber lens. Through the pressure exerted on the interior wall of the internal sleeve by a deformation of the first and the second arresting spring, the portion of the first and second chamber located diametrically opposite to the groove also presses against the interior wall of the internal sleeve. Hence, when the fixed pin moves along the first and the second sliding groove to drive the first and the second lens chamber inside the internal sleeve and vary the focus in a variable focus system, the first and the second lens chamber rarely wobble. In other words, the point of impact shift is minimized when the focus is varied because the first and the second lens chamber can move smoothly inside the internal sleeve. Furthermore, although an arc-shaped elastic plate is used inside the groove to reduce tolerance in the aforementioned variable focus system, anyone familiar with the technology may use an elastic circular ring, an axial sheath or a soft pad to improve the point of impact shift.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A multi-chip package structure, comprising:
a first chip, having a first active surface;
a patterned lamination layer, disposed directly on a portion area of the first active surface, wherein the first chip has a plurality of first bonding pads disposed on the first active surface exposed by the patterned lamination layer and the patterned lamination layer has a plurality of second bonding pads disposed thereon;
a plurality of first bumps;
a second chip, having a second active surface, wherein the first bumps are disposed on the second active surface and the second chip is electrically connected to the first bonding pads through the first bumps; and
a plurality of second bumps, disposed on the second bonding pads.

2. The multi-chip package structure of claim 1, wherein a size of the second chip is smaller than an area of the first active surface exposed by the patterned lamination layer.

3. The multi-chip package structure of claim 1, wherein the patterned lamination layer comprises a ring type pattern or a multi-stripe type pattern.

4. The multi-hip package structure of claim 1, wherein the patterned lamination layer comprises a re-distribution circuit layer.

5. The multi-chip package structure of claim 1, wherein the patterned lamination layer comprises a component circuit layer electrically integrated with the first chip.

6. The multi-chip package structure of claim 1, wherein the patterned lamination layer has a first thickness T1, the second chip has a second thickness T2, each first bump has a first height H1 and each second bump has a second height H2, and T1+H2>T2+H1.

7. The multi-chip package structure of claim 1, further comprising a carrier electrically connected to the first chip through the second bumps.

8. A multi-chip package structure, comprising:
a first chip, having a first active surface;
a patterned lamination layer, disposed directly on a portion of the first active surface, wherein the first chip has a plurality of fit bonding pads disposed on the first active surface exposed by the patterned lamination layer and the patterned lamination layer has a plurality of second bonding pads disposed thereon;
a plurality of fist bumps;
a second chip, having a second active surface, wherein the first bumps are disposed on the second active surface and the second chip is electrically connected to a portion of the first bonding pads through the first bumps;
a component, disposed on the first chip, wherein the component is electrically connected to the other first bonding pads of the first chip; and
a plurality of second bumps, disposed on the second bonding pads.

9. The multi-chip package structure of claim 8, wherein a size of the second chip is smaller than an area of the first active surface exposed by the patterned lamination layer.

10. The multi-chip package structure of claim 8, wherein the patterned lamination layer comprises a ring type pattern or a multi-stripe type pattern.

11. The multi-chip package structure of claim 8, wherein the patterned lamination layer comprises a re-distribution circuit layer.

12. The multi-chip package structure of claim 8, wherein the patterned lamination layer comprises a component circuit layer electrically integrated with the first chip.

13. The multi-chip package structure of claim 8, wherein the component comprises a surface mount device.

14. The multi-chip package structure of claim 8, further comprising a plurality of third bumps disposed on the other first bonding pads such that the component is electrically connected to the first chip.

15. The multi-chip package store of claim 8, wherein the patterned lamination layer has a first thickness T1, the second chip has a second thickness T2, each first bump has a first height H1 and each second bump has a second height H2, and T1+H2>T2+H1.

16. The multi-chip package structure of claim 8, further comprising a carrier electrically connected to the first chip through the second bumps.
